(19) United States
(12) Patent Application Publication
(10) Pub. No.: US 2024/0371391 A1
(43) Pub. Date: Nov. 7, 2024

(54) NOISE SUPPRESSION FOR AUDIO SYSTEMS

(71) Applicant: SKYWORKS SOLUTIONS, INC., Irvine, CA (US)

(72) Inventor: Alexander KAIN, Portland, OR (US)

(21) Appl. No.: 18/651,705

(22) Filed: May 1, 2024

Related U.S. Application Data
(60) Provisional application No. 63/463,242, filed on May 1, 2023.

(51) Int. Cl. G10L 21/0364; G10L 21/0272

(52) U.S. Cl. CPC G10L 21/0364; G10L 21/0272

(57) ABSTRACT

A method for processing audio signals can include receiving an audio signal and separating the audio signal into a first audio component and a second audio component. The method can further include providing a gain for each of the first and second audio components to result in a respective gain adjusted audio component. The method can further include combining the first and second gain adjusted audio components to provide a processed audio signal, with the gains of the first and second audio components being configured so that a selected one of the first and second audio components has improved intelligibility by a listener when the processed audio signal is converted into sound by a speaker.

### CROSS-REFERENCE TO RELATED APPLICATION(S)

This application claims priority to U.S. Provisional Application No. 63/463,242 filed May 1, 2023 entitled NOISE SUPPRESSION FOR AUDIO SYSTEMS, the disclosure of which is hereby expressly incorporated by reference herein in its entirety.

### BACKGROUND

### Field

The present disclosure relates to noise suppression for audio systems.

### Description of the Related Art

An audio-visual system such as a home theater system typically includes an audio system that provides sound for a user based on content such as a movie. Such a movie soundtrack often contains very loud sounds or music scores that can obscure speech, thereby making the speech difficult to understand.

### SUMMARY

In accordance with some implementations, the present disclosure relates to a method for processing audio signals. The method includes receiving an audio signal and separating the audio signal into a first audio component and a second audio component. The method further includes providing a gain for each of the first and second audio components to result in a respective gain adjusted audio component. The method further includes combining the first and second gain adjusted audio components to provide a processed audio signal, with the gains of the first and second audio components being configured so that a selected one of the first and second audio components has improved intelligibility by a listener when the processed audio signal is converted into sound by a speaker.

In some embodiments, the selected audio component can include a speech component, and the other audio component can include a non-speech component. In some embodiments, the non-speech sound can include substantially all of the audio signal except the speech component.

In some embodiments, the selected audio component can include a non-speech component. In some embodiments, the non-speech component can include music. In some embodiments, the other audio component can include a speech component.

In some embodiments, the separating of the audio signal can include processing the audio signal with at least some artificial intelligence (AI) functionality.

In some embodiments, the providing of the gain for each of the first and second audio components can include providing suppression or no suppression of the respective audio component. The providing of the suppression can include a suppression range such that the suppressed audio component has a level in a range between first and second levels, with the first level being less than a level associated with no suppression, and the second level being greater than or equal to a level associated with complete suppression.

In some embodiments, the providing of the gain for each of the first and second audio components can include providing suppression, no change or enhancement of the respective audio component.

In some embodiments, the providing of the gain for each of the first and second audio components can include receiving gain information from a user interface. The gain information can be configured to provide a continuous or finely-adjustable range of values. The gain information can be selected from a set of suggested gain values.

In some embodiments, the audio signal can be a digital signal. In some embodiments, the processed audio signal can be a digital signal.

In some implementations, the present disclosure relates to a method for processing audio/video (AV) signals. The method includes receiving an AV signal having an audio signal and a video signal, and processing the audio signal. The processing of the audio signal includes separating the audio signal into a first audio component and a second audio component, and providing a gain for each of the first and second audio components to result in a respective gain adjusted audio component. The processing of the audio signal further includes combining the first and second gain adjusted audio components to provide a processed audio signal, with the gains of the first and second audio components being configured so that a selected one of the first and second audio components has improved intelligibility by a listener when the processed audio signal is converted into sound by a speaker.

In some embodiments, the method can further include merging the processed audio signal with the video signal to provide a processed AV signal.

In some implementations, the present disclosure relates to an audio processor that includes an input circuit configured to receive an audio signal, and a splitter configured to separate the audio signal into a first audio component and a second audio component. The audio processor further includes a gain circuit configured to provide a gain for each of the first and second audio components to result in a respective gain adjusted audio component. The audio processor further includes a combiner configured to combine the first and second gain adjusted audio components to provide a processed audio signal, with the gains of the first and second audio components being configured so that a selected one of the first and second audio components has improved intelligibility by a listener when the processed audio signal is converted into sound by a speaker.

In some implementations, the present disclosure relates to an audio system that includes an input circuit configured to receive an audio signal, and an audio processor that includes a splitter configured to separate the audio signal into a first audio component and a second audio component, and a gain circuit configured to provide a gain for each of the first and second audio components to result in a respective gain adjusted audio component. The audio processor further includes a combiner configured to combine the first and second gain adjusted audio components to provide a processed audio signal, with the gains of the first and second audio components being configured so that a selected one of the first and second audio components has improved intelligibility by a listener when the processed audio signal is converted into sound.

In some embodiments, the system can further include a speaker configured to provide the sound based on the processed audio signal.

In some implementations, the present disclosure relates to an audio/video (AV) system that includes an input circuit configured to receive an AV signal having an audio signal and a video signal, and an audio processor that includes a splitter configured to separate the audio signal into a first audio component and a second audio component, and a gain circuit configured to provide a gain for each of the first and second audio components to result in a respective gain adjusted audio component. The audio processor further includes a combiner configured to combine the first and second gain adjusted audio components to provide a processed audio signal, with the gains of the first and second audio components being configured so that a selected one of the first and second audio components has improved intelligibility by a listener when the processed audio signal is converted into sound.

In some embodiments, the AV system can further include a merging circuit configured to merge the processed audio signal with the video signal to provide a processed AV signal. In some embodiments, the AV system can further include a speaker configured to provide the sound based on the processed audio signal. In some embodiments, the AV system can further include a screen configured to provide a display based on the video signal.

In some implementations, the present disclosure relates to an electronic device that includes an input circuit configured to receive an input signal that includes an audio signal, and an audio processor that includes a splitter configured to separate the audio signal into a first audio component and a second audio component. The audio processor further includes a gain circuit configured to provide a gain for each of the first and second audio components to result in a respective gain adjusted audio component. The audio processor further includes a combiner configured to combine the first and second gain adjusted audio components to provide a processed audio signal, with the gains of the first and second audio components being configured so that a selected one of the first and second audio components has improved intelligibility by a listener when the processed audio signal is converted into sound.

In some embodiments, the electronic device can further include a speaker configured to provide the sound based on the processed audio signal.

In some embodiments, the electronic device can be configured to receive and process the audio signal representative of a radio broadcast.

In some embodiments, the electronic device can be a television device.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows an audio system that can be configured to provide an output sound having a selected content such as speech that is easier to understand by a user.

FIG. 2 shows a more generalized processing architecture that can be implemented for the audio processor of FIG. 1.

FIG. 3 shows an architecture that can be a more specific example of the architecture of FIG. 2.

FIG. 4 shows a system having an audio processing system similar to the example of FIG. 3.

FIG. 5 shows an example of a user interface that can be provided to allow a user to change gain settings of speech gain and non-speech gain in a continuous or in fine steps.

FIG. 6 shows an example of a user interface that can be provided to allow a user to select among a limited number of descriptive categories.

FIG. 7 shows that in some embodiments, a separated audio component can be provided with gain that provides suppression, retention or enhancement of the audio component's level.

FIG. 8 shows an architecture that can be implemented to provide improved intelligibility of an audio component that is different than a speech component.

FIG. 9 shows that in some embodiments, an architecture can be configured to separate an audio signal into more than two audio components.

FIG. 10 shows a process that can be implemented in the system of FIG. 2.

FIG. 11 shows a process that can be a more specific example of the process of FIG. 10.

### DETAILED DESCRIPTION OF SOME EMBODIMENTS

The headings provided herein, if any, are for convenience only and do not necessarily affect the scope or meaning of the claimed invention.

An audio-visual system such as a home theater system typically includes an audio system that provides sound for a user based on content such as a movie. In the example context of such a home theater system, it is noted that movie soundtracks often contain very loud sounds and/or music scores that can obscure speech, thereby making the speech difficult to understand. Such difficulty in understanding of speech can be especially pronounced for elderly or hearing-impaired users.

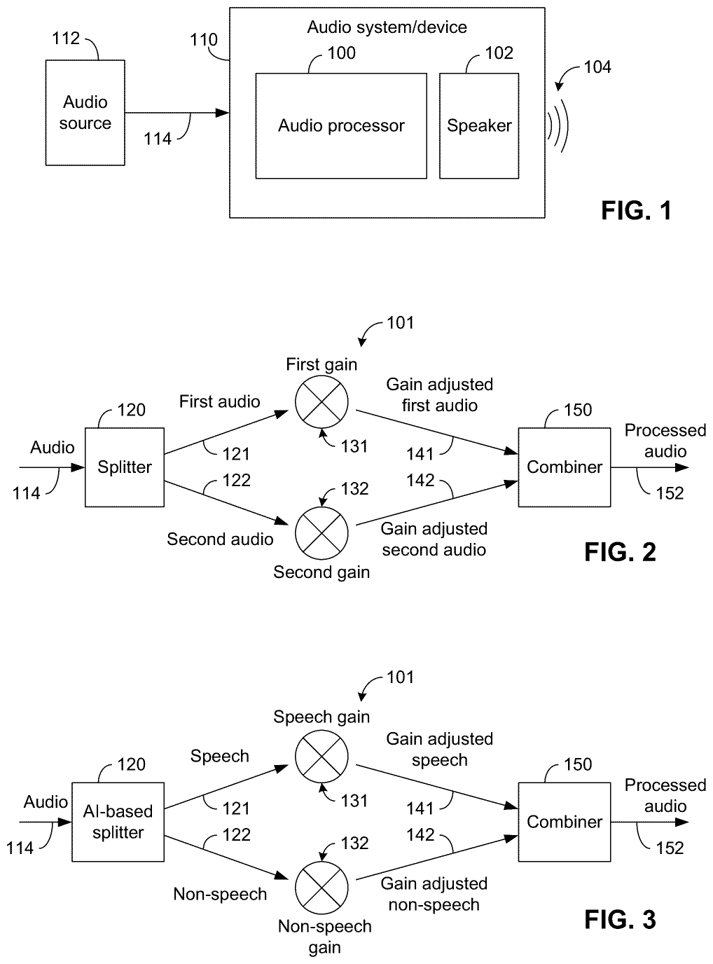

FIG. 1 shows an audio system 110 that can be configured to provide an output sound 104 having a selected content such as speech that is easier to understand by a user. It will be understood that the audio system 110 can be implemented in a single device or a plurality of devices.

Referring to FIG. 1, the audio system 110 is shown to include an audio processor 100 that processes an input signal 114 from an audio source 112. The input signal 114 may be an analog signal or a digital signal, and can be provided to the audio system 110 in a wired manner, wireless manner, or some combination thereof. The audio source 112 can be, for example, local media, streaming service, etc.

The audio processor 100 can be configured to provide one or more functionalities as described herein, in digital domain, analog domain, or some combination thereof, and provide a driving signal for one or more speakers collectively indicated as 102. The speaker(s) 102 is/are shown to provide the above-referenced output sound 104.

In some embodiments, the audio processor 100 of FIG. 1 can include an artificial intelligence (AI) functionality, and such an AI functionality can be utilized to separate a soundtrack of the input signal 114 into clean speech and everything else (also referred to herein as non-speech or noise). Either or both of such speech and non-speech portions can be provided with adjusted gain(s) and then combined back to generate a processed audio output having a desired level of gain for each of the speech and non-speech portions. Thus, and as an example, if the speech portion retains the original gain level while the non-speech portion is suppressed by a reduced gain level, the resulting audio output can result in the speaker sound having speech that is easier to understand.

In the foregoing example, AI functionality can be utilized to provide speech as a preferred audio component; however, it will be understood that one or more features of the present disclosure can also be implemented with non-AI functionality and/or for a preferred audio component other than speech.

Accordingly, FIG. 2 shows a more generalized processing architecture 101 that can be implemented for the audio processor 100 of FIG. 1. In the architecture 101 of FIG. 2, an audio signal 114 is shown to be provided to a splitter 120. In some embodiments, such a splitter can be configured to separate the audio signal 114 into a first audio content 121 and a second audio content 122.

In some embodiments, one of the first and second audio components 121, 122 can be a selected audio component for which a desired change such as an improved understandability can be provided for a user, and the other audio component can be everything else in the audio signal 114. In such a configuration, substantially all components of the audio signal 114 can be accounted for in the outputs of the splitter 120.

In some embodiments, each of the first and second audio components 121, 122 can be a specific audio component in the audio signal 114. In such a configuration, there may or may not be remaining component(s) in the outputs of the splitter 120.

Referring to FIG. 2, the first audio component 121 is shown to be provided with a first gain 131 so as to yield a gain adjusted first audio component 141, and the second audio component 122 is shown to be provided with a second gain 132 so as to yield a gain adjusted second audio component 142. The gain adjusted first and second audio components 141, 142 are shown to be combined by a combiner 150 so as to provide a processed audio signal 152. It is noted that the input audio signal 114 and the processed audio signal 152 can be digital signals, analog signals, or some combination thereof. It is also noted that the processed audio signal 152 can be utilized to, for example, drive an audio amplifier which in turn can drive one or more speakers.

In the example of FIG. 2, one can see that by providing desired gains for either or both the separated first and second audio signals 121, 122, the resulting processed audio signal 152 can have at least one audio component (e.g., the first audio component) that is different (e.g., higher level) than that present in the input audio signal 114.

FIG. 3 shows an architecture 101 that can be a more specific example of the architecture 101 of FIG. 2. More particularly, FIG. 3 shows that in some embodiments, a splitter 120 can include AI functionality, and such an AI functionality can be utilized to separate an input audio signal 114 into speech content as a first audio content 121 and non-speech content as a second audio content 122. In some embodiments, the non-speech content 122 can include substantially all of sound components remaining in the input audio signal 114 after the separation of the speech component 121 by the splitter 120.

Referring to FIG. 3, and similar to the example of FIG. 2, the speech component 121 is shown to be provided with a speech gain 131 so as to yield a gain adjusted speech component 141, and the non-speech component 122 is shown to be provided with a non-speech gain 132 so as to yield a gain adjusted non-speech component 142. The gain adjusted speech and non-speech components 141, 142 are shown to be combined by a combiner 150 so as to provide a processed audio signal 152. The processed audio signal 152 can be utilized to, for example, drive an audio amplifier which in turn can drive one or more speakers.

In the example of FIG. 3, one can see that by providing desired gains for either or both the separated speech and non-speech components 121, 122, the resulting processed audio signal 152 can have at least one audio component (e.g., the speech component) that is different (e.g., higher level) than that present in the input audio signal 114.

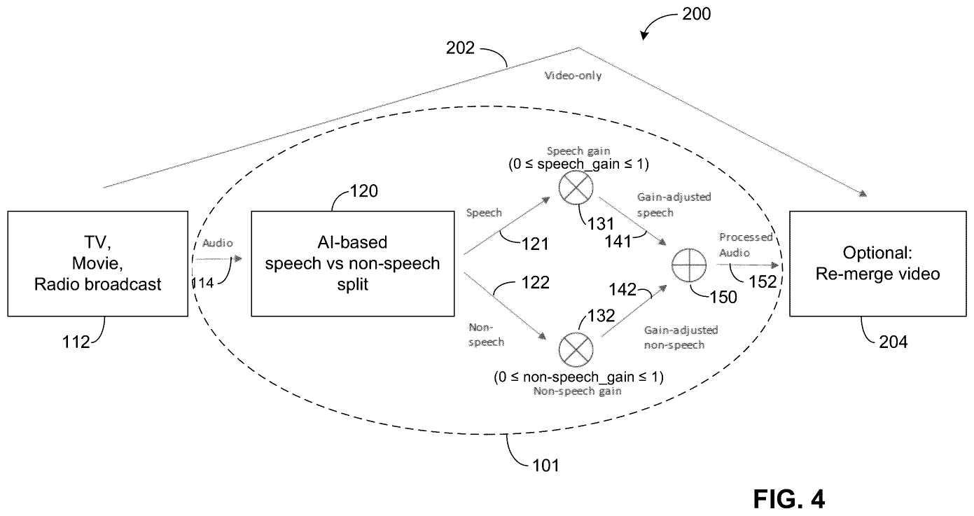

FIG. 4 shows a system 200 having an audio processing system 101 similar to the example of FIG. 3. The system 200 of FIG. 4, however, can be configured to process audio-visual signals. Thus, a signal source 112 can provide, for example, a TV signal (audio and video), a movie signal (audio and video), and/or a radio broadcast (audio).

In the context of a source signal having both audio (114) and video (202) signals, the audio signal 114 can be processed as described in reference to FIG. 3 to provide a processed audio signal 152. Such a processed audio signal 152 can be re-merged with the video signal 202 by a combiner 204 to provide an output signal.

In the example of FIG. 4, the speech gain 131 can be configured to provide a gain in a range 0≤speech_gain≤1. Similarly, the non-speech gain 132 can be configured to provide a gain in a range 0≤non_speech_gain≤1. In such a configuration, a gain of 1 can correspond to an output having the same level as an input, and a gain less than 1 can correspond to an output having a suppressed level relative to an input level, with a gain of 0 corresponding to substantially complete suppression.

In the foregoing gain example, and in the example context of enhancing understandability of speech, speech_gain can be set at 1.0, and non-speech_gain can be set to be less than 1.0 and greater than or equal to 0. Such gain settings can effectively lower the volume of non-speech sound such as music, special effects, and/or environmental noises to thereby provide better speech intelligibility and easier listening effort.

In some embodiments, the speech gain (speech_gain) and non-speech gain (non-speech_gain) can be selected by a user utilizing, for example, physical control inputs (e.g., on a speaker device) or user interface (e.g., on a TV or monitor screen, and/or on a casting device such as a tablet or smartphone). Such selection of gains can be configured to provide approximately continuous variations or in a number of descriptive categories.

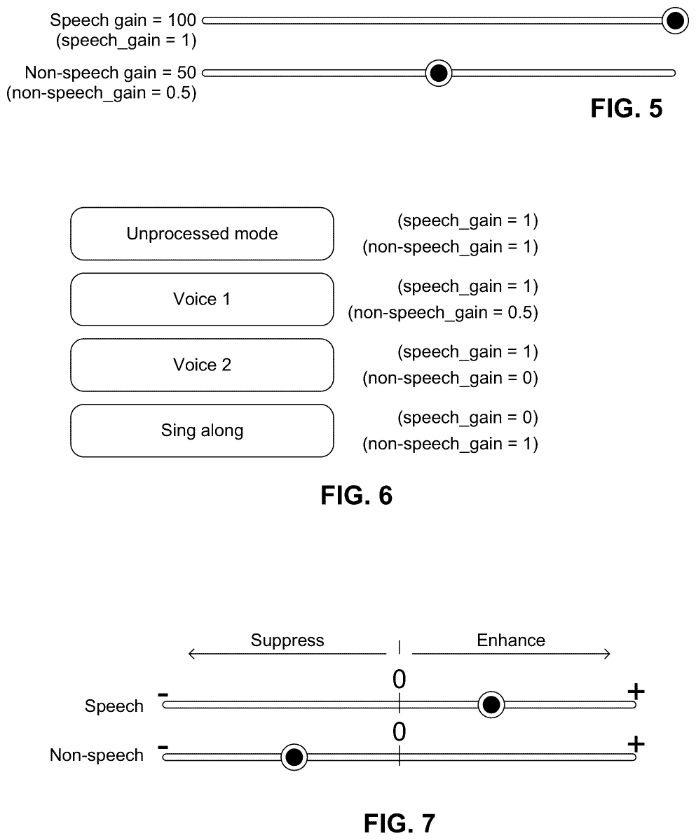

FIG. 5 shows an example of a user interface that can be provided to allow a user to change gain settings of speech gain and non-speech gain in a continuous or in fine steps. For example, a sliding button can be provided in a range of 0 to 100, with 0 corresponding to gain=0 and 100 corresponding to gain=1 (in the context of the example of FIG. 4). In the example of FIG. 5, the speech gain is shown to be set at 100 (speech_gain=1), and the non-speech gain is set at 50 (non-speech_gain=0.5).

FIG. 6 shows an example of a user interface that can be provided to allow a user to select among a number of descriptive categories. For example, four categories are shown with each category selectable by touch or a pointer. The first category can be an unprocessed mode that, if selected, provides speech_gain=1 and non-speech_gain=1. The second category can be “Voice 1” mode that, if selected, provides speech_gain=1 and non-speech_gain=0.5 to provide improved speech intelligibility while retaining suppressed non-speech sound. The third category can be “Voice 2” mode that, if selected, provides speech_gain=1 and non-speech_gain=0 to provide speech while generally removing suppressing non-speech sound.

In the examples of FIGS. 4 and 5, improved speech intelligibility is provided by providing speech component with higher gain relative to non-speech component. However, it will be understood that a non-speech component can be selected for improved hearing experience. For example, suppose that a “karaoke mode” mode is desired where a singer's voice is suppressed or removed completely while retaining non-speech music to allow a user to sing along.

FIG. 6 shows that in some embodiments, speech_gain can be suppressed or removed completely while retaining non-speech content of an input signal. Such a mode is depicted as a “Sing along” mode that, if selected, provides speech_gain=0 and non-speech_gain=1 to suppress or remove speech (e.g., singing voice sound) while retaining non-speech sound (e.g., background music).

In the examples of FIGS. 4 to 6, it is assumed that gains for speech and non-speech can be provided by no-suppression or suppression of respective separated audio components. However, it will be understood that gains can be provided in other ways.

For example, FIG. 7 shows that in some embodiments, a separated audio component can be provided with gain that provides suppression, retention or enhancement of the audio component's level. For example, a user interface similar to the example of FIG. 5 is shown to provide adjustability of speech and non-speech levels. For each of speech and non-speech, a slidable button can provide suppression (less than 0), retention (0) or enhancement (greater than 0). Thus, in the example context where speech intelligibility is desired, the speech gain can be set to provide a gain greater than 0, and the non-speech gain can be set to provide a gain less than 0.

As described herein in reference to FIG. 6, there may be situations where speech is not necessarily a desirable component. For example, music sound may be desirable with or without singer's vocal sound.

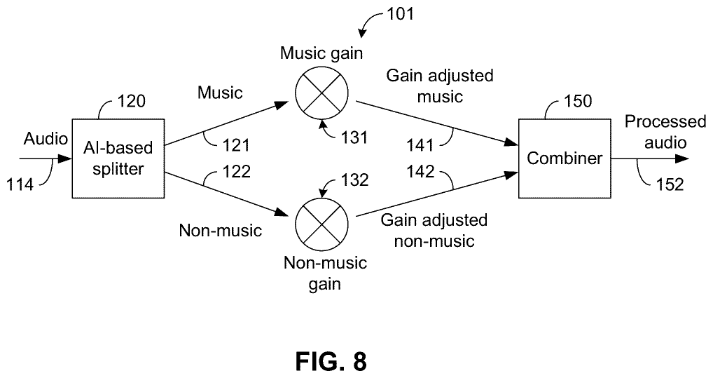

FIG. 8 shows an architecture 101 that can be implemented to provide improved intelligibility of an audio component that is different than a speech component. The example architecture 101 of FIG. 8 is shown in the example context where improved intelligibility is desired for music; however, it will be understood that a similar architecture can be configured to provide improved intelligibility for an audio component other than music or speech.

In the example of FIG. 8, the architecture 101 is similar to the architecture 101 of FIG. 3, with speech being replaced with music. It will be understood that such music may or may not include vocal component. It will also be understood that the architecture 101 of FIG. 8 can be implemented in an audio-video system similar to the audio-video system 200 of FIG. 4.

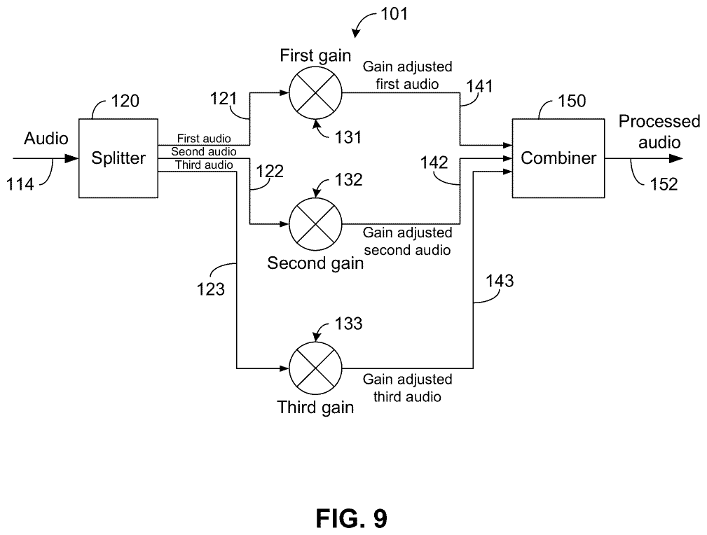

FIG. 9 shows that in some embodiments, an architecture 101 can be configured to separate an audio signal 114 into more than two audio components. In FIG. 9, first and second audio components and their respective processing paths can be similar to the architecture 101 of FIG. 2. In FIG. 9, a third audio component 123 separated by the splitter 120 is shown to be provided with a gain 133 to result in a gain adjusted third audio component 143; and the three gain adjusted audio components 141, 142, 143 are shown to be combined by a combiner 150 to provide a processed audio signal 152.

It will be understood that gain adjustability of the architecture 101 of FIG. 9 can be provided as described herein. It will also be understood that the architecture 101 of FIG. 9 can be implemented in an audio-video system similar to the audio-video system 200 of FIG. 4.

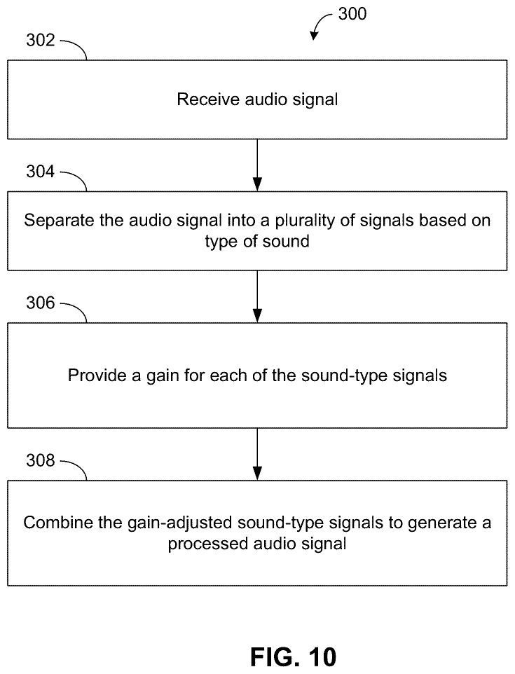

FIG. 10 shows a process 300 that can be implemented in a system such as the system 101 of FIG. 2. In block 302, an audio signal can be received. In block 304, the audio signal can be processed to separate the audio signal into a plurality of audio components based on a type of sound. In block 306, a gain can be provided for each of the sound-type components. In block 308, the gain-adjusted sound-type components can be combined to generate a processed audio signal.

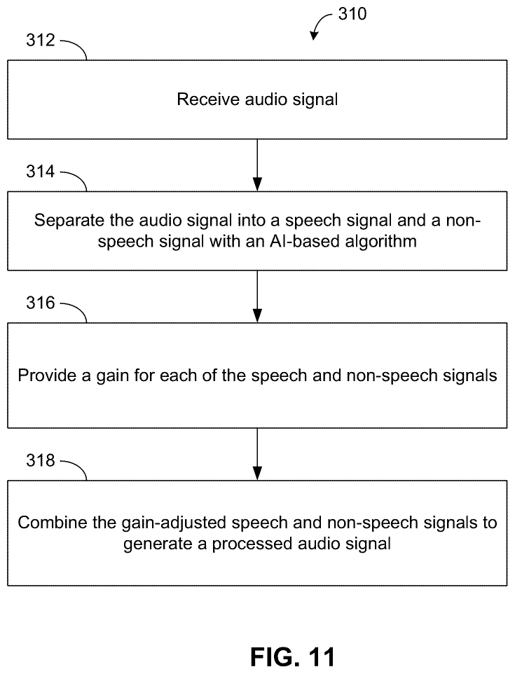

FIG. 11 shows a process 310 that can be a more specific example of the process 300 of FIG. 10. In some embodiments, the process 310 can be implemented in a system such as the systems 101 of FIGS. 3 and 4. In block 312, an audio signal can be received. In block 314, the audio signal can be processed to separate the audio signal into a speech component and a non-speech component. In some embodiments, such separation into speech and non-speech components can be achieved by an AI-based algorithm. In block 316, a gain can be provided for each of the speech and non-speech components. In block 318, the gain-adjusted speech and non-speech components can be combined to generate a processed audio signal.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A method for processing audio signals, the method comprising:
receiving an audio signal;
separating the audio signal into a first audio component and a second audio component;
providing a gain for each of the first and second audio components to result in a respective gain adjusted audio component; and
combining the first and second gain adjusted audio components to provide a processed audio signal, the gains of the first and second audio components configured so that a selected one of the first and second audio components has improved intelligibility by a listener when the processed audio signal is converted into sound by a speaker.

2. The method of claim 1 wherein the selected audio component includes a speech component.

3. The method of claim 2 wherein the other audio component includes a non-speech component.

4. The method of claim 3 wherein the non-speech sound includes substantially all of the audio signal except the speech component.

5. The method of claim 1 wherein the selected audio component includes a non-speech component.

6. The method of claim 5 wherein the non-speech component includes music.

7. The method of claim 5 wherein the other audio component includes a speech component.

8. The method of claim 1 wherein the separating of the audio signal includes processing the audio signal with at least some artificial intelligence (AI) functionality.

9. The method of claim 1 wherein the providing of the gain for each of the first and second audio components includes providing suppression or no suppression of the respective audio component.

10. The method of claim 9 wherein the providing of the suppression includes a suppression range such that the suppressed audio component has a level in a range between first and second levels, the first level being less than a level associated with no suppression, the second level being greater than or equal to a level associated with complete suppression.

11. The method of claim 1 wherein the providing of the gain for each of the first and second audio components includes providing suppression, no change or enhancement of the respective audio component.

12. The method of claim 1 wherein the providing of the gain for each of the first and second audio components includes receiving gain information from a user interface.

13. The method of claim 12 wherein the gain information is configured to provide a continuous or finely-adjustable range of values.

14. The method of claim 12 wherein the gain information is selected from a set of suggested gain values.

15. The method of claim 1 wherein the audio signal is a digital signal.

16. The method of claim 1 wherein the processed audio signal is a digital signal.

17. A method for processing audio/video (AV) signals, the method comprising:
receiving an AV signal having an audio signal and a video signal; and
processing the audio signal, the processing including separating the audio signal into a first audio component and a second audio component, and providing a gain for each of the first and second audio components to result in a respective gain adjusted audio component, the processing further including combining the first and second gain adjusted audio components to provide a processed audio signal, the gains of the first and second audio components configured so that a selected one of the first and second audio components has improved intelligibility by a listener when the processed audio signal is converted into sound by a speaker.

18. The method of claim 17 further comprising merging the processed audio signal with the video signal to provide a processed AV signal.

19. (canceled)

20. An audio system comprising:
an input circuit configured to receive an audio signal; and
an audio processor including a splitter configured to separate the audio signal into a first audio component and a second audio component, and a gain circuit configured to provide a gain for each of the first and second audio components to result in a respective gain adjusted audio component, the audio processor further including a combiner configured to combine the first and second gain adjusted audio components to provide a processed audio signal, the gains of the first and second audio components configured so that a selected one of the first and second audio components has improved intelligibility by a listener when the processed audio signal is converted into sound.

21. The system of claim 20 further comprising a speaker configured to provide the sound based on the processed audio signal.

22. (canceled)

23. (canceled)

24. (canceled)

25. (canceled)

26. (canceled)

27. (canceled)

28. (canceled)

29. (canceled)
